(19) United States
(12) Patent Application Publication
(10) Pub. No.: US 2005/0185438 A1
(43) Pub. Date: Aug. 25, 2005

(54) Low profile removable memory module

(76) Inventor: Wei Ching, Menlo Park, CA (US)

Correspondence Address: HAVERSTOCK & OWENS LLP, 162 NORTH WOLFE ROAD, SUNNYVALE, CA, 94086, US

(21) Appl. No.: 11/031,369

(22) Filed: Jan. 6, 2005

Related U.S. Application Data
(60) Provisional application No. 60/535,079, filed on Jan. 7, 2004.

(51) Int. Cl. G06F 13/38

(52) U.S. Cl. 365/52

(57) ABSTRACT

A removable memory module is designed for connection with a host device using a data port positioned on a face of the host device. The removable memory module comprises a substantially planar body defining a plane and having a memory circuit, and a data interface for connecting with the data port of the host and exchanging data The data interface is coupled with the body to allow communication with the memory circuit and positioned so that when the data interface is connected to the data port on the host, the planar body is positionable so that the plane defined thereby is substantially parallel to the face of the host device on which the data port is positioned.

### RELATED APPLICATIONS

This application claims priority under 35 U.S.C. §119(e) to the co-pending U.S. Provisional Patent Application Ser. No. 60/535,079 filed Jan. 7, 2004, and titled “A Unique Right-Angle USB Key Design.” The U.S. Provisional Patent Application Ser. No. 60/535,079 filed Jan. 7, 2004, and titled “A Unique Right-Angle USB Key Design” is hereby incorporated by reference.

### FIELD OF THE INVENTION

The present invention relates to the field of removable memory media. More particularly, the present invention relates to removable memory media which is insertable into a data port of a host device.

### BACKGROUND OF THE INVENTION

Recently, portable, removable memory modules have gained widespread acceptance. Generally, these memory modules are used in a host digital device that includes a display screen. Examples of such digital devices include digital cameras, personal computers, and personal digital assistants (PDAs).

The traditional shape of these modules mimics the keys with which they are often carried: usually long and thin. As can be seen in FIG. 1, which illustrates a prior art USB key drive, a prior art device comprises a single main body 120, with a Universal Serial Bus (USB) plug 10 coupled to or incorporated within the body. In most devices the USB plug extends from one end of the body, directed along a major axis of that body. This construction is advantageous when carrying such a device, because it results in a compact geometry well-suited to fit into a pocket, for example.

However, this typical construction does not provide optimal convenience and safety when the USB plug is coupled for data transfer with a host digital device. Such a construction necessitates that when the USB plug is attached to a host digital device, the body of the module extends outward along its longest axis from the USB port of the host device. Thus, when in operation, the body is optimally positioned as a lever arm to exert force on the plug interface. Further, because this positioning extends the longest axis of the module outward from the plug, it creates an irregular and awkward extension from the host device. In this configuration, accidental collisions with the module are very likely.

Such collisions can result in a wide array of damage to the device, or inconvenience to the user. For example, disconnection during data transfer in the best scenario will simply require the inconvenience of repeating the transfer, in some cases it can result in damage to the flash memory module and/or the host device. Further, a collision with a device in a plugged-in configuration can easily damage the USB interface, or break the internal components of the memory module, rendering it useless.

In addition, the typical construction of USB memory devices does little to mitigate the threat of theft. The protrusion of these devices from their host devices makes them eye-catching and obvious to any person seeking to steal one. Further, current USB memory devices lack physical security features to prevent such theft. Since these devices are often relied upon to transport sensitive data and are even sometimes used as security keys to gain access to particular computer systems, their physical theft presents a real risk to their users. Despite the availability of password protection for the data stored therein, the physical loss of the data still presents a great security risk.

### SUMMARY OF THE DISCLOSURE

The present invention is directed to removable memory devices. According to the embodiments of the present invention, a removable memory module is provided. The memory module is designed for connection with a host device using a data port positioned on a face of the host device. The module of the present invention comprises a substantially planar body having a memory circuit, wherein a substantially planar body defines a plane, and a data interface for connecting with the data port of the host and exchanging data, coupled with the body to allow communication with the memory circuit therein and positioned thereon so that when the data interface is connected to the data port on the host, the planar body is positionable so that the plane defined thereby is substantially parallel to the face of the host device on which the data port is positioned.

According to further aspects of the present invention, the host device and the removable memory device exchange data through the data interface and the data port according to a standardized protocol. The standardized protocol is preferably Universal Serial Bus, but it is understood that any suitable standardized protocol including, without limitation, IEEE 1394 will work.

In the memory module of the present invention, the data interface is optionally fixedly or moveably positioned on the planar body. In the preferred embodiment of the memory module according to the present invention, the data interface is fixedly positioned on the planar body.

In the memory module of the present invention, the substantially planar body optionally comprises one or more additional components designed to increase the utility of the module to a user. It is understood that these components are optionally implemented either all together or in any suitable combination thereof. According to the present invention, the substantially planar body comprises one or more sections modified to enhance a grip. Also, the substantially planar body comprises an adhesive portion configured to allow attachment to the face of the host device when the data interface is connected to the data port and the body is positioned so that the plane defined thereby is substantially parallel to the face of the host device on which the data port is positioned. Further, the substantially planar body comprises a moveable handle to aid gripping and to allow connection thereto of a key ring.

The memory circuit of the present invention comprises any suitable data storage device, including, but not limited to, flash memory. In the preferred embodiment, the memory circuit comprises a plurality of flash cells and an integral controller operatively coupled to the flash cells.

The memory module of the present invention is designed to achieve a low profile when coupled to the host device. In accordance with that goal, in the preferred embodiment of the present invention, the substantially planar body extends no more than one centimeter from the face of the host device when the data interface is connected to the data port and the body is positioned so that the plane defined thereby is substantially parallel to the face of the host device on which the data port is positioned.

The embodiments of the present invention also describe a removable memory module for connection using a standardized protocol with a host device having fixedly positioned thereon a data receptacle in accordance with the standardized protocol. The removable memory module comprises a substantially planar body having a memory circuit, and a data interface according to the standardized protocol for connecting with the data receptacle of the host and exchanging data, fixedly coupled with the body to allow communication with the memory circuit therein and positioned thereon so that when the data interface is connected to the data receptacle on the host, the substantially planar body is positioned so that the plane defined thereby is substantially parallel to the face of the host device on which the data receptacle is positioned.

In another aspect, the embodiments of the present invention describe a removable memory module for connection using a data port of a host device having a first three-dimensional shape with a first surface area. The removable memory module comprises a substantially planar body having a memory circuit, and a data interface for connecting with the data port of the host device and exchanging data, coupled with the body to allow communication with the memory circuit therein and positioned thereon so that when the data interface is connected to the data port on the host, the substantially planar body is in a fixed position relative to the host device, whereby a combination of the device and the module has a second three-dimensional shape with a second surface area. Further, the fixed position of the substantially planar body relative to the device is such that the difference in magnitude between the second surface area and the first surface area is minimized.

In an embodiment of the present invention, a Universal Serial Bus key drive is provided. The key drive comprises a substantially planar body having a memory module, and a male Universal Serial Bus connector coupled with the substantially planar body and positioned so that the direction of insertion into a female Universal Serial Bus receptacle is substantially perpendicular to the plane defined by the substantially planar body. Preferably the female and male Universal Serial Bus connectors are type A female and type A male Universal Serial Bus connectors.

In a further embodiment of the present invention, an ultra low profile USB key drive is provided. This key drive comprises a thin, substantially planar body having a portion of a memory module therein, and a male USB connector coupled with the substantially planar body and positioned so that the direction of insertion into a female Universal Serial Bus receptacle is substantially perpendicular to the plane defined by the substantially planar body. Further, another portion of the memory module is integrally formed with the male USB connector. Preferably the female and male Universal Serial Bus connectors are type A female and type A male Universal Serial Bus connectors.

In another aspect, the present invention describes the integration of a memory module or portion thereof into a housing of a standardized data interface. In this aspect, the data interface has a physical structure consisting of housings and other components, which is prescribed by the data interface standard. In the present invention, known fabrication techniques are used to form housings and other components that meet the data interface standard, but which also contain memory modules or portions thereof which are accessible through the standardized data interface.

The embodiments of the present invention further describe a removable memory module. The memory module is designed for connection with a host device using a data port positioned on a face of the host device. The module of the present invention comprises a substantially planar body having a memory circuit, wherein a substantially planar body defines a plane, and a data interface for connecting with the data port of the host and exchanging data, coupled with the body to allow communication with the memory circuit therein and positioned thereon so that when the data interface is connected to the data port on the host, the planar body is positionable so that the plane defined thereby is substantially parallel to the face of the host device on which the data port is positioned. Furthermore, a latching mechanism is provided with the memory module. The latching mechanism is actuated by a mechanical lock coupled with the substantially planar body.

In one embodiment, the mechanical lock is actuated by a key. Also, the latch mechanism may be implemented in any reasonable way. In one embodiment, the latch mechanism is integrally formed with the data interface and, when actuated, prevents removal of the removable memory module from the data port of the host. In another embodiment the latch is coupled with the data interface and with the substantially planar body. If the latch mechanism is actuated while the memory module is coupled with the data port of the host device it prevents removal of the removable memory module from the data port of the host. In a further embodiment of the latch mechanism according to the present invention, the latch comprises two components, a first component designed for permanent attachment with the host device, and a second component permanently attached with the memory module. When actuated, the latch mechanism couples the first component to the second component. The first and the second components are designed so that the first may be permanently attached with the host device so that, when the memory module is connected with the data port of the host device, the first and second components are proximate with one another and actuation of the latch mechanism at that point in time will couple the first component with the second component.

### BRIEF DESCRIPTION OF THE DRAWINGS

FIG. 1 shows a prior art USB key drive.

FIG. 2 is a perspective view of an embodiment of the present invention having a fixed, centered USB interface thereon.

FIG. 3 is a perspective view of an embodiment of the present invention having a fixed, offset USB interface thereon.

FIG. 4 is a perspective view of an embodiment of the present invention having a moveable USB interface thereon.

FIG. 5 is a schematic illustration of the memory circuit within a device according to the present invention.

FIG. 6 is a side view of a memory module according to an embodiment of the present invention with a host device.

FIG. 7 is a side view of view of a memory module according to an embodiment of the present invention with a host device.

FIG. 8 shows a perspective view of an ultra low profile removable memory module according the present invention.

FIG. 9 shows a removable memory module comprising a lock and latching mechanism according to the present invention.

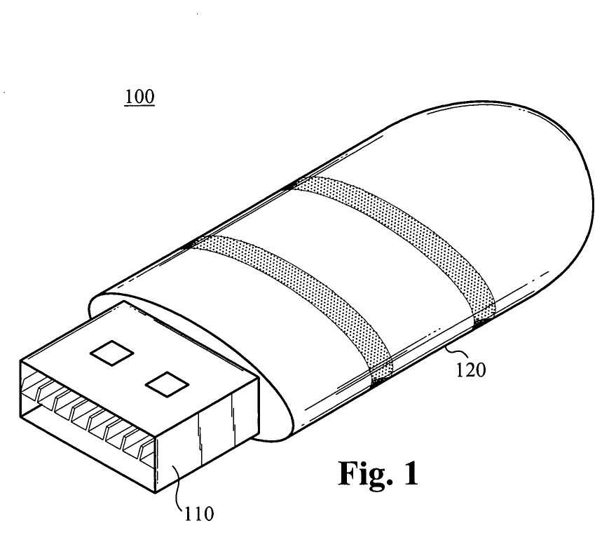

### DETAILED DESCRIPTION OF THE EMBODIMENTS

According to the present invention, a removable memory device is designed to minimize its protrusion from a host device when it is coupled thereto for transfer of data. In accordance with the embodiments of the present invention, several removable memory module designs are contemplated, as will be explained fully below.

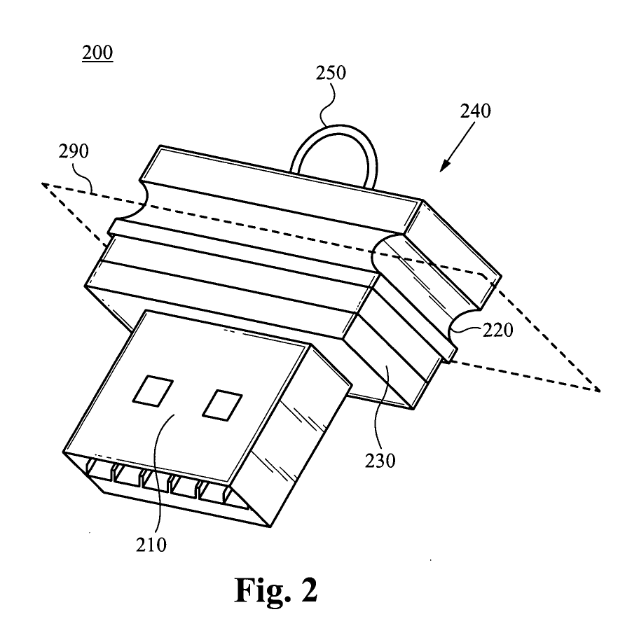

In FIG. 2, a removable memory module 200 according to the present invention is shown. The memory module 200 is designed for removable connection with a host device using a data port positioned on a face of the host device. The memory module comprises a substantially planar body 240 having a memory circuit therein. The body 240 defines a plane 290. The memory module 200 further comprises a data interface 210, which is preferably a USB male connector as illustrated. The interface 210 is coupled with the body 240 for communication with the memory circuit therein. Further, the memory module 200 is positioned on the body 240 so that when the data interface 210 is connected to the data port of the host, the substantially planar body is positioned so that the plane 290 defined thereby is substantially parallel to the face of the host device on which the data port is positioned.

As FIG. 2 illustrates, additional features present on the substantially planar body 240. The sections 220 are modified to enhance a grip on the module 200. The adhesive portion 230 is configured to allow attachment to the face of the host device when the data interface 210 is connected to the data port and the body is positioned so that the plane 290 defined thereby is substantially parallel to the face of the host device on which the data port is positioned. The moveable handle 250 is designed to aid gripping and to allow connection of the module 200 with a key ring. The movable handle 250 is also configured to fold against the body 240 when the module 200 is plugged into a host device. Preferably, the substantially planar body 240 and the adhesive portion 230 are of a size such that the substantially planar body 240 extends no more than one centimeter from the face of the host device when the data interface 210 is connected to the data port and the body is positioned so that the plane 290 defined thereby is substantially parallel to the face of the host device on which the data port is positioned.

In the module 200, the body 240 and the interface 210 are positioned relative to one another so that the interface 210 is substantially centered on the face of the substantially planar body 240 that is coupled to the adhesive portion 230. Preferably, the dimensions of the substantially planar body 240 are chosen so that when the data interface 210 is in this centered configuration relative to the body 240, the module 200 will not hinder access to any other data ports on the host device when it is coupled to a data port on the host device for data transfer.

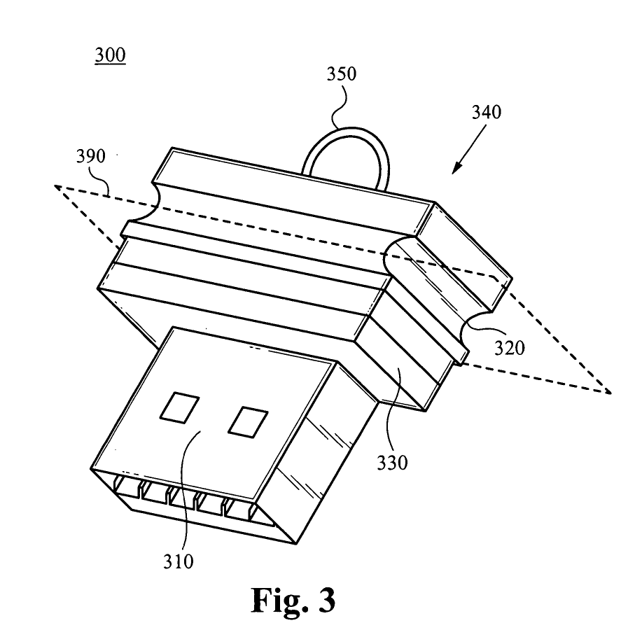

FIG. 3 illustrates a removable memory module 300 for connection using a data port of a host device having a first three-dimensional shape with a first surface area. The removable memory module 300 comprises a substantially planar body 340 having a memory circuit, wherein the substantially planar body 340 defines a plane 390, and a data interface 310 for connecting with the data port of the host device and exchanging data, coupled with the body 340 to allow communication with the memory circuit. Further, the data interface 310 is positioned on the body 340 so that one surface of the interface 310 is flush with one surface of the body 340. Because of this placement, when the data interface 310 is connected to the data port on the host, the substantially planar body 340 is in a fixed position relative to the host device, whereby a combination of the device and the module 300 has a second three-dimensional shape with a second surface area. In the module 300 the fixed position of the substantially planar body 340 relative to the device is such that the difference in magnitude between the second surface area and the first surface area is minimized.

FIG. 3 illustrates additional features present on the substantially planar body 340. The sections 320 are modified to enhance a grip on the module 300. The adhesive portion 330 is configured to allow attachment to the face of the host device when the data interface 310 is connected to the data port. The moveable handle 350 is designed to aid gripping and to allow connection of the module 300 with a key ring. The movable handle 350 is also configured to fold against the body 340 when the module 300 is plugged into a host device. Preferably, the substantially planar body 340 and the adhesive portion 330 are of a size such that the substantially planar body 340 extends no more than one centimeter from the face of the host device when the data interface 310 is connected to the data port.

In the module 300, the body 340 and the interface 310 are positioned relative to one another so that the interface 310 is substantially positioned on one edge of the face of the substantially planar body 340 that is coupled to the adhesive portion 330. Preferably, the dimensions of the substantially planar body 340 are chosen so that when the data interface 310 is in this offset configuration relative to the body 340, the module 300 will not hinder access to any other data ports on the host device when it is coupled to a data port on the host device for data transfer.

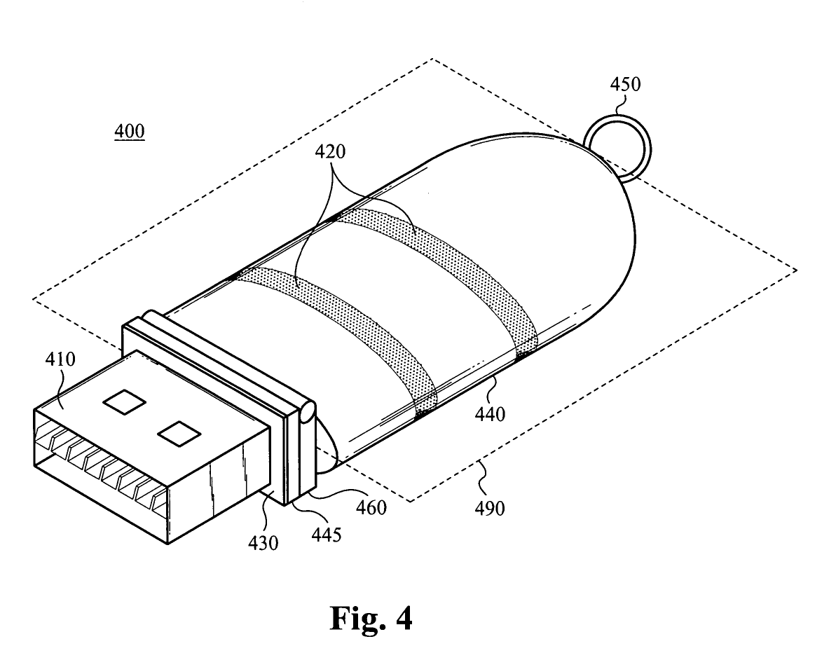

FIG. 4 illustrates a removable memory module 400 in accordance with the embodiments of the present invention. This removable memory module 400 is designed for connection using a standardized protocol with a host device having fixedly positioned thereon a data receptacle in accordance with the standardized protocol. The removable memory module of the present invention comprises a substantially planar body 440 having a memory circuit, wherein the substantially planar body 440 defines a plane 490, a base body 445 movably coupled with the substantially planar body by the hinge 460, and a data interface 410 according to the standardized protocol for connecting with the data receptacle of the host and exchanging data, coupled with the base body 445 and therethrough with the substantially planar body 440 to allow communication with the memory circuit therein and positioned thereon so that when the data interface 410 is connected to the data receptacle on the host, the substantially planar body 440 is positionable so that the plane 490 defined thereby is substantially parallel to a face of the host device on which the data receptacle is positioned.

FIG. 4 illustrates additional features present on the substantially planar body 440. The sections 420 are modified to enhance a grip on the module 400. The adhesive portion 430 is configured to allow attachment to the face of the host device when the data interface 410 is connected to the data port. The moveable handle 450 is designed to aid gripping and to allow connection of the module 400 with a key ring. The movable handle 450 is also configured to fold against the body 440 when the module 400 is plugged into a host device. Preferably, the substantially planar body 440 and the adhesive portion 430 are of a size such that the substantially planar body 440 extends no more than one centimeter from the face of the host device when the data interface 410 is connected to the data port and the substantially planar body 440 is positioned so that the plane 490 defined thereby is substantially parallel to a face of the host device on which the data receptacle is positioned.

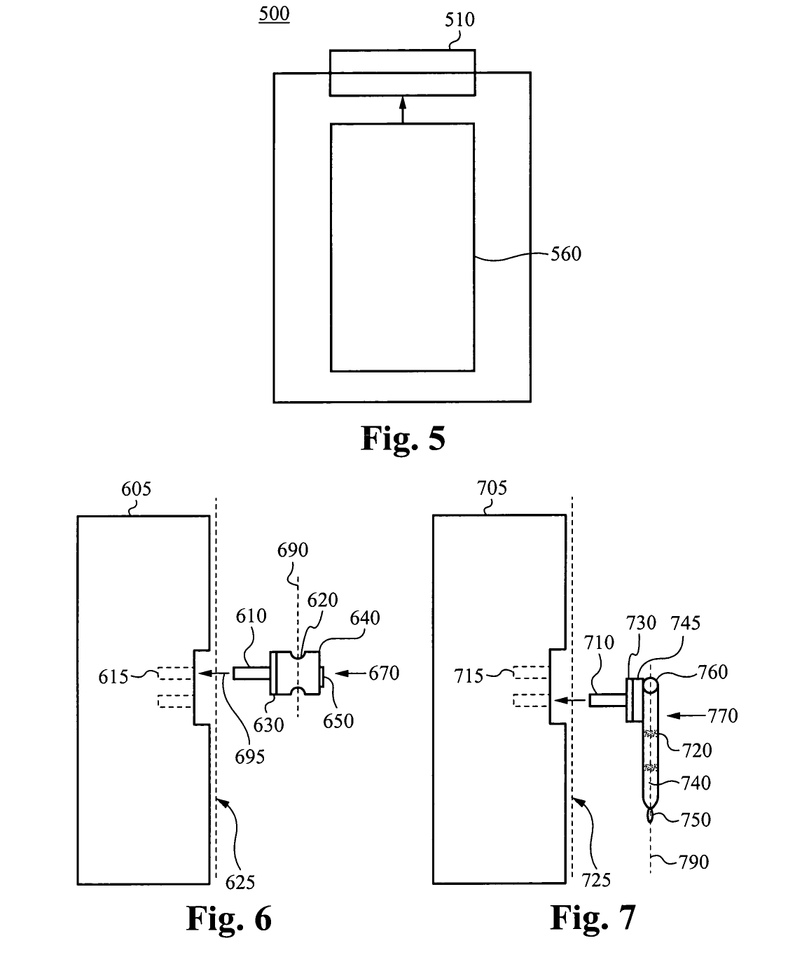

FIG. 5 illustrates a schematic view of the memory module 500 according to the embodiments of the present invention. The memory module 500 includes the memory circuit 560, which is coupled with the data interface 510. The memory circuit 560 preferably comprises a flash memory cell. While the architecture of the memory module 500 preferably includes flash memory cells, this architecture is representative only and any conventional architecture using flash or other memory cells can be used according to the teachings of the present invention.

FIG. 6 illustrates a memory module 670 according to the present invention coupling with a host device 605. As can be seen, since a USB female connector 615 is coupled in a direction perpendicular to a plane 625 that is tangent to at least a portion of the device 605 which contains the female connector 615, any plane 625 defined by a face of a host device 605 containing a USB female connector 615 coupled with the memory module 670 will be substantially parallel with the plane 690. The arrow 695 illustrates the coupling of the memory module 670 with the host device 605. The memory module 670 comprises a substantially planar body 640 coupled with a data interface 610. Further, additional features are present on the planar body 640. The sections 620 are modified to enhance a grip on the module 670. The adhesive portion 630 is configured to allow attachment to the face of the host device when the data interface 610 is connected to the data port. The moveable handle 650 is designed to aid gripping and to allow connection of the module 670 with a key ring. The movable handle 650 is also configured to fold against the body 640 when the module 670 is plugged into a host device. Preferably, the substantially planar body 640 and the adhesive portion 630 are of a size such that the substantially planar body 640 extends no more than one centimeter from the face of the host device when the data interface 610 is connected to the data port and the substantially planar body 640 is positioned so that the plane 690 defined thereby is substantially parallel to a face of the host device on which the data receptacle is positioned.

FIG. 7 illustrates a memory module 770 according to the present invention coupling with a host device 705. As can be seen, since a USB female connector 715 is coupled in a direction perpendicular to a plane 725 that is tangent to at least a portion of the device 705 which contains the female connector 715, any plane 725 defined by a face of a host device 705 containing a USB female connector 715 coupled with the memory module 770 will be substantially parallel with the plane 790. The arrow 795 illustrates the coupling of the memory module 770 with the host device 705. The memory module 770 comprises a substantially planar body 740 movably coupled with a base body 745 through a hinge 760. The base body 745 is coupled to a data interface 710. Further, additional features are present on the planar body 740. The sections 720 are modified to enhance a grip on the module 770. The adhesive portion 730 is configured to allow attachment to the face of the host device when the data interface 710 is connected to the data port. The moveable handle 750 is designed to aid gripping and to allow connection of the module 770 with a key ring. The movable handle 750 is also configured to fold against the body 740 when the module 770 is plugged into a host device. Preferably, the substantially planar body 740 and the adhesive portion 730 are of a size such that the substantially planar body 740 extends no more than one centimeter from the face of the host device when the data interface 710 is connected to the data port and the substantially planar body 740 is positioned so that the plane 790 defined thereby is substantially parallel to a face of the host device on which the data receptacle is positioned.

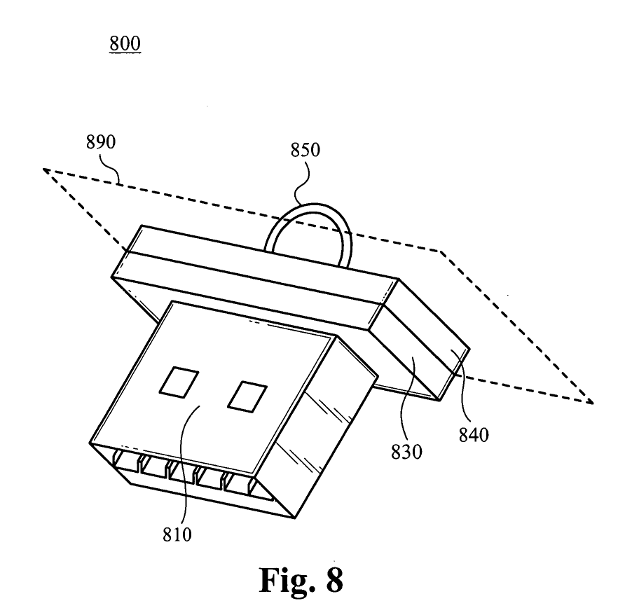

FIG. 8 illustrates an ultra low profile removable memory module 800 according to the present invention. The memory module 800 comprises the substantially planar body 840, coupled with the data interface 810. The memory module 800 further comprises a memory circuit (not shown). The memory module 800 connects with a host device through a data port to exchange data. The substantially planar body 840 is aligned along a plane 890. According to the present invention, the data interface 810 is positioned relative to the substantially planar body 840 so that, when the data interface 810 is coupled with the data port on the host device for exchanging data, the plane 890 defined by the substantially planar body 840 is substantially parallel with a face of the host device.

According to the present invention, the memory module 800 further comprises components designed to provide enhancing features. As shown in FIG. 8, the memory module 800 further comprises the adhesive portion 830 designed to adhere to the host device when the memory module 800 is coupled with the host device for data transfer. Further, the memory module 800 comprises the moveable handle 850, coupled with the substantially planar body to aid gripping and to allow connection of the module 800 with a key ring.

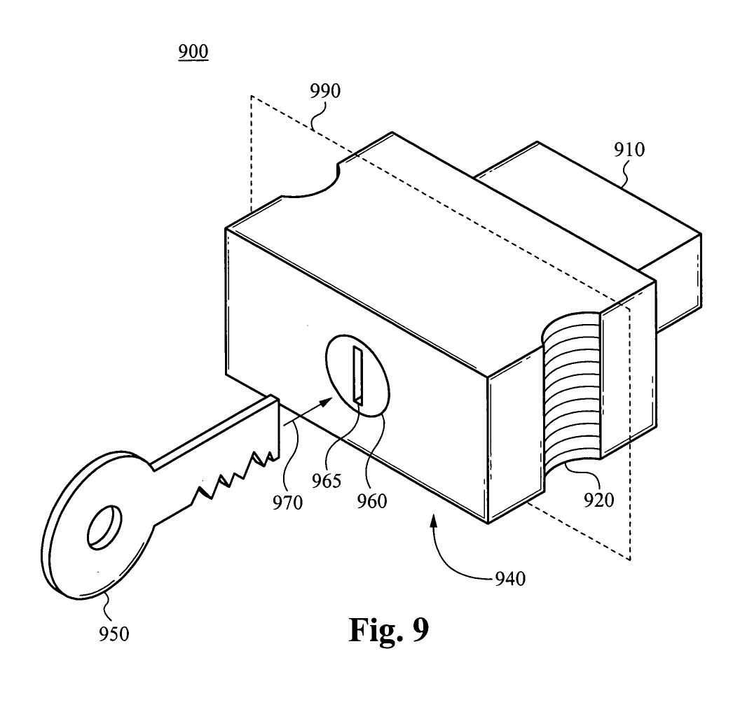

FIG. 9 illustrates a removable memory module 900 according to a further aspect of the present invention. The memory module 900 is designed for connection using a data port of a host device having a first three-dimensional shape with a first surface area. The removable memory module 900 comprises a substantially planar body 940 having a memory circuit, wherein the substantially planar body 940 defines a plane 990, and a data interface 910 for connecting with the data port of the host device and exchanging data, coupled with the body 940 to allow communication with the memory circuit. The data interface 910 is positioned so that, when the data interface 910 is connected to the data port on the host, the substantially planar body 940 is in a fixed position relative to the host device, whereby a combination of the device and the module 900 has a second three-dimensional shape with a second surface area. In the module 900 the fixed position of the substantially planar body 940 relative to the device is such that the difference in magnitude between the second surface area and the first surface area is minimized.

FIG. 9 illustrates additional features present on the substantially planar body 940. The sections 920 are modified to enhance a grip on the module 900. The module 900 further comprises the lock core 960 having the key hole 965. The lock core 960 is actuated by insertion of the key 950 into the key hole 965 as illustrated by the arrow 970. Once inserted, the key 950 is turned, which rotates the lock core 960 and subsequently actuates a latch mechanism (not shown) or rotated in the opposite direction which releases the latch mechanism. As shown in FIG. 9, the key 950 is able to be removed from the memory module 900. In another embodiment, the key 950 is integrated within and permanently affixed to the memory module 900. The latch mechanism is designed to couple the memory module 900 with the host device when the memory module 900 is coupled with the host device for data exchange. The latch mechanism engages with a corresponding component attached onto the host device, so that when the memory module 900 is connected with the data port of the host device, the latch mechanism and the corresponding receiving component on the host device are proximate with one another and actuation of the latch mechanism at that point in time will latch the memory module 900 to the host device. The memory module 900 can then only be removed from the host device by unlatching the latch mechanism. In one embodiment, the substantially planar body 940 is of a size such that the substantially planar body 940 extends no more than one centimeter from the face of the host device when the data interface 910 is connected to the data port.

A memory module in accordance with the embodiments of the present invention is positionable to have a relatively low profile when coupled with a host device for data transfer. The low profile of the memory module of the present invention provides significant advantages over prior art devices by reducing the chances of accidental collisions with the module while coupled with the host device. This reduction results in a reduced chance of device damage or catastrophic data loss, either or both of which may result from collision with a memory module device.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiment chosen for illustration without departing from the spirit and scope of the invention.

1. A removable memory module for connection with a host device using a data port positioned on a face of the host device, comprising:
a) a substantially planar body having a memory circuit, wherein the substantially planar body defines a plane; and
b) a data interface for connecting with the data port of the host and exchanging data, coupled with the body to allow communication with the memory circuit therein and positioned thereon so that when the data interface is connected to the data port on the host, the substantially planar body is positionable so that the plane defined thereby is substantially parallel to the face of the host device on which the data port is positioned.

2. The module of claim 1, wherein the data interface and the data port exchange data according to a standardized protocol.

3. The module of claim 2, wherein the standardized protocol is Universal Serial Bus.

4. The module of claim 1, wherein the data interface is fixedly positioned on the substantially planar body.

5. The module of claim 1, wherein the data interface is moveably positioned on the substantially planar body.

6. The module of claim 1, wherein the substantially planar body comprises one or more sections modified to enhance a grip.

7. The module of claim 1, wherein the substantially planar body comprises a moveable handle to aid gripping and to allow connection thereto of a key ring.

8. The module of claim 1, wherein the substantially planar body comprises an adhesive portion configured to allow attachment to the face of the host device when the data interface is connected to the data port and the substantially planar body is positioned so that the plane defined thereby is substantially parallel to the face of the host device on which the data port is positioned.

9. The module of claim 1, wherein the memory circuit comprises a plurality of flash cells and an integral controller operatively coupled to the flash cells.

10. The module of claim 1, wherein the substantially planar body extends no more than 1 centimeter from the face of the host device when the data interface is connected to the data port and the substantially planar body is positioned so that the plane defined thereby is substantially parallel to the face of the host device on which the data port is positioned.

11. A removable memory module for connection using a data port of a host device having a first three-dimensional shape with a first surface area, comprising:
a) a substantially planar body having a memory circuit, wherein the substantially planar body defines a plane; and
b) a data interface for connecting with the data port of the host device and exchanging data, coupled with the substantially planar body to allow communication with the memory circuit therein and positioned thereon so that when the data interface is connected to the data port on the host, the substantially planar body is in a fixed position relative to the host device, whereby a combination of the device and the module has a second three-dimensional shape with a second surface area;
wherein, the fixed position of the substantially planar body relative to the device is such that the difference in magnitude between the second surface area and the first surface area is minimized.

12. The module of claim 11, wherein the data interface and the data port exchange data according to a standardized protocol.

13. The module of claim 12, wherein the standardized protocol is Universal Serial Bus.

14. The module of claim 11, wherein the substantially planar body comprises one or more sections modified to enhance a grip.

15. The module of claim 11, wherein the substantially planar body comprises a moveable handle to aid gripping and to allow connection thereto of a key ring.

16. The module of claim 11, wherein the memory circuit comprises a plurality of flash cells and an integral controller operatively coupled to the flash cells.

17. The module of claim 11, wherein the substantially planar body extends no more than 1 centimeter from the face of the host device when the data interface is connected to the data port.

18. A removable memory module for connection using a standardized protocol with a host device having fixedly positioned thereon a data receptacle in accordance with the standardized protocol, comprising:
a) a substantially planar body having a memory circuit, wherein the substantially planar body defines a plane; and
b) a data interface according to the standardized protocol for connecting with the data receptacle of the host and exchanging data, fixedly coupled with the substantially planar body to allow communication with the memory circuit therein and positioned thereon so that when the data interface is connected to the data receptacle on the host, the substantially planar body is positioned so that the plane defined thereby is substantially parallel to a face of the host device on which the data receptacle is positioned.

19. The module of claim 18, wherein the standardized protocol is Universal Serial Bus.

20. The module of claim 18, wherein the substantially planar body comprises one or more sections modified to enhance a grip.

21. The module of claim 18, wherein the substantially planar body comprises a moveable handle to aid gripping and to allow connection thereto of a key ring.

22. The module of claim 18, wherein the substantially planar body comprises an adhesive portion configured to allow attachment to the face of the host device when the data interface is connected to the data receptacle and the substantially planar body is positioned so that the plane defined thereby is substantially parallel to the face of the host device on which the data receptacle is positioned.

23. The module of claim 18, wherein the memory circuit comprises a plurality of flash cells and an integral controller operatively coupled to the flash cells.

24. The module of claim 18, wherein the substantially planar body extends no more than 1 centimeter from the face of the host device when the data interface is connected to the data receptacle and the substantially planar body is positioned so that the plane defined thereby is substantially parallel to the face of the host device on which the data receptacle is positioned.

25. A Universal Serial Bus key drive comprising:
a) a substantially planar body defining a plane and having a memory module; and,
b) a male Universal Serial Bus connector coupled with the substantially planar body and positioned so that the direction of insertion into a female Universal Serial Bus receptacle is substantially perpendicular to the plane defined by the substantially planar body.

26. The module of claim 25, wherein the male Universal Serial Bus connector is fixedly positioned on the substantially planar body.

27. The module of claim 25, wherein the male Universal Serial Bus connector is moveably positioned on the substantially planar body.

28. The module of claim 25, wherein the substantially planar body comprises one or more sections modified to enhance a grip.

29. The module of claim 25, wherein the substantially planar body comprises a moveable handle to aid gripping and to allow connection thereto of a key ring.

30. The module of claim 25, wherein the substantially planar body comprises an adhesive portion configured to allow non-permanent attachment to the face of the host device when the male Universal Serial Bus connector is coupled with the female Universal Serial Bus receptacle

31. The module of claim 25, wherein the memory circuit comprises a plurality of flash cells and an integral controller operatively coupled to the flash cells.

32. The module of claim 25, wherein the substantially planar body extends no more than 1 centimeter from the face of the host device when the male Universal Serial Bus connector is coupled with the female Universal Serial Bus receptacle.

33. The module of claim 25, wherein the female and male Universal Serial Bus connectors are type A female and type A male Universal Serial Bus connectors.

34. A removable memory module for connection with a host device using a data port positioned on a face of the host device, comprising:
a) a substantially planar body having a memory circuit, wherein the substantially planar body defines a plane; and
b) a data interface for connecting with the data port of the host and exchanging data, movably coupled with the body to allow communication with the memory circuit therein and movable so that when the data interface is connected to the data port on the host, the substantially planar body is positionable so that the plane defined thereby is substantially parallel to the face of the host device on which the data port is positioned.

35. The module of claim 34, wherein the data interface and the data port exchange data according to a standardized protocol.

36. The module of claim 35, wherein the standardized protocol is Universal Serial Bus.

37. The module of claim 34, wherein the substantially planar body comprises one or more sections modified to enhance a grip.

38. The module of claim 34, wherein the substantially planar body comprises a moveable handle to aid gripping and to allow connection thereto of a key ring.

39. The module of claim 34, wherein the substantially planar body is coupled with a base body that is fixedly coupled with the data interface, and where the base body comprises an adhesive portion configured to allow attachment to the face of the host device when the data interface is connected to the data port.

40. The module of claim 34, wherein the memory circuit comprises a plurality of flash cells and an integral controller operatively coupled to the flash cells.

41. The module of claim 34, wherein the substantially planar body extends no more than 1 centimeter from the face of the host device when the data interface is connected to the data port and the substantially planar body is positioned so that the plane defined thereby is substantially parallel to the face of the host device on which the data port is positioned.

42. A removable memory module for physical coupling with a host device for data exchange, comprising:
a) a substantially planar body defining a plane and having a memory circuit; and
b) a male Universal Serial Bus connector coupled with the substantially planar body and positioned so that the direction of insertion into a female Universal Serial Bus receptacle is substantially perpendicular to the plane defined by the substantially planar body;
wherein the removable memory module further comprises a locking latch mechanism for substantially preventing physical decoupling of the removable memory module from the host device, when the removable memory module is coupled therewith for data exchange.
